(19) United States
(12) Patent Application Publication
(10) Pub. No.: US 2026/0105765 A1
(43) Pub. Date: Apr. 16, 2026

(54) LABELING TRAINING DATA USING HIGH-VOLUME NAVIGATION DATA

(71) Applicant: Tesla, Inc., Austin, TX (US)

(72) Inventors: Yekeun JEONG, Austin, TX (US); Amay SAXENA, Austin, TX (US); Shichao YANG, Austin, TX (US); Daniel LU, Austin, TX (US); Arvind RAMANANDAN, Austin, TX (US); Comran MORSHED, Austin, TX (US); Julius YEH, Austin, TX (US); Ritika SHRIVASTAVA, Austin, TX (US); Zahra GHAED, Austin, TX (US); Ivan GOZALI, Austin, TX (US); Alon DAKS, Austin, TX (US); Alex XIAO, Austin, TX (US); Ashok Kumar ELLUSWAMY, Austin, TX (US)

(73) Assignee: Tesla, Inc., Austin, TX (US)

(21) Appl. No.: 19/115,728

(22) PCT Filed: Sep. 29, 2023
(86) PCT No.: PCT/US2023/034091

§ 371 Date: Mar. 26, 2025

Related U.S. Application Data
(60) Provisional application No. 63/377,954, filed on Sep. 30, 2022.

(51) Int. Cl. G06V 20/70; G06T 17/05

(52) U.S. Cl. CPC G06V 20/70; G06T 17/05

(57) ABSTRACT

Disclosed herein are methods and systems for automatic labeling of image data for machine learning training purposes. A method comprises retrieving navigation data and image data from a set of egos navigating through an environment comprising at least one feature; generating a three-dimensional (3D) model of the environment using the navigation data and image data of at least a subset of the set of egos, the 3D model comprising a virtual representation of the at least one feature of the environment; identifying a machine learning label associated with the at least one feature within the image data; receiving second navigation data and second image data from a second ego not included within the set of egos, the second ego navigating the environment, the second image data including the at least one feature; automatically generating a machine learning label for the at least one feature depicted within the second image data.

### CROSS-REFERENCE TO RELATED PATENT APPLICATIONS

The present application claims priority to U.S. Provisional Application No. 63/377,954, filed Sep. 30, 2022, which is incorporated herein by reference in its entirety for all purposes.

### TECHNICAL FIELD

The present disclosure generally relates to training artificial intelligence models using navigational data.

### BACKGROUND

Autonomous navigation technology used for autonomous vehicles and robots (collectively, egos) has become ubiquitous due to rapid advancements in computer technology. These advances allow for safer and more reliable autonomous navigation of egos. Egos often use sophisticated artificial intelligence (AI) models to identify their surroundings (e.g., objects and drivable surfaces occupying the egos'surroundings) and to make navigational decisions.

Generating these AI models presents various technical challenges. For instance, labeling training data is often an inefficient and resource-intensive process because it requires human labelers to categorize and tag thousands of data points captured within navigational data. For instance, human reviews may review camera footage of various vehicles navigating through a specific area and label various objects, such as lane markings, sidewalks, and the like. This process can be both time-consuming and expensive. Moreover, this process is error-prone because it highly depends on the human labeler's subjective knowledge and understanding.

For the aforementioned reasons, manual labeling data is inefficient, time-consuming, and subject to human error, leading to potential inaccuracies that can adversely affect the performance of AI models.

### SUMMARY

For the aforementioned reasons, there is a desire for methods and systems that can efficiently label navigational data. For instance, there is a need for an automated system/method to ingest navigational data captured by one or more egos/vehicles (e.g., camera feed of a vehicle driving within a region) and to automatically label the navigational data while reducing (or sometimes eliminating) the need for human intervention.

The methods and systems discussed herein provide a labeling framework to allow automatic labeling that is also model-agnostic. A non-limiting example of a model that can be trained using the data automatically labeled is an AI model related to the autonomous navigation of egos. The methods and systems discussed herein can provide a framework with which large amounts of data can be automatically labeled. Various egos now have the ability to gather data from a multitude of trips (also referred to herein as “navigation sessions”), potentially involving millions of data points. Compared with other labeling methods, the framework discussed herein can significantly decrease overall training time and decrease the processing power needed to label this voluminous data. The methods and systems discussed herein also provide an approach to auto-labeling that is scalable.

The auto-labeling process discussed herein may consist of three steps. The first step may involve high-precision trajectory and structure recovery using image data and navigational data captured by a set of egos (e.g., multi-camera visual-inertial odometry or VIO). The second step may involve executing a multi-trip reconstruction protocol in which multiple trips (from different egos) and their corresponding data are aligned and aggregated. In order to achieve this, the methods and systems discussed herein may utilize coarse alignment protocols, pairwise matching protocols, joint optimization protocols, and surface refinement protocols. The multi-trip reconstruction may be finalized by human analysts. As a result, a model (sometimes in 3D) representing an environment may be created. The protocols involved in generating the model may be parallelized in order to increase efficiency. The third step may involve auto-labeling new trips, using the generated model.

The auto-labeling methods discussed herein may allow an automated framework to label various types of data that can be used for object detection models, kinematic analysis models, shape analysis models, occupancy/surface detection models, and the like. Therefore, the methods and system discussed herein may apply to various models as these methods are model-agnostic. Using the methods and systems discussed may eliminate the need for human intervention in training AI models.

In an embodiment, a method comprises retrieving, by a processor, a set of navigation data and image data from a set of egos navigating within an environment comprising at least one feature; generating, by the processor, a three-dimensional (3D) model of the environment using the navigation data and image data of at least a subset of the set of egos, the 3D model comprising a virtual representation of the at least one feature of the environment; identifying, by the processor, a machine learning label associated with the at least one feature within the image data; receiving, by the processor, second navigation data and second image data from a second ego not included within the set of egos, the second ego navigating within the environment, the second image data including the at least one feature; and automatically generating, by the processor, a machine learning label for the at least one feature depicted within the second image data.

The method may further comprise filtering, by the processor, the set of navigation data and image data into a subset of the set of navigation data and image data in accordance with a trajectory of each ego within the set of egos.

The method may further comprise localizing, by the processor, the second ego using the second navigation data or the second image data in accordance with the 3D model.

The at least one feature may be at least one of a drivable surface, a traffic sign, a traffic light, lane lines, or a 3D structure.

The method may further comprise transmitting, by the processor, the machine learning label and the second image data to an artificial intelligence model.

The artificial intelligence model may be an occupancy detection model.

The method may further comprise executing, by the processor, an artificial intelligence model to predict the machine learning label associated with the at least one feature within the image data.

The method may further comprise receiving, by the processor from a human reviewer, a validation regarding the machine learning label associated with the at least one feature within the image data predicted by the artificial intelligence model.

In another embodiment, a computer-readable medium comprises a set of instructions that when executed, cause a processor to retrieve a set of navigation data and image data from a set of egos navigating within an environment comprising at least one feature; generate a three-dimensional (3D) model of the environment using the navigation data and image data of at least a subset of the set of egos, the 3D model comprising a virtual representation of the at least one feature of the environment; identify a machine learning label associated with the at least one feature within the image data; receive second navigation data and second image data from a second ego not included within the set of egos, the second ego navigating within the environment, the second image data including the at least one feature; and automatically generate a machine learning label for the at least one feature depicted within the second image data.

The set of instructions further may cause the processor to filter the set of navigation data and image data into a subset of the set of navigation data and image data in accordance with a trajectory of each ego within the set of egos.

The set of instructions further may cause the processor to localize the second ego using the second navigation data or the second image data in accordance with the 3D model.

The at least one feature is at least one of a drivable surface, a traffic sign, a traffic light, lane lines, or a 3D structure.

The set of instructions further cause the processor to transmit the machine learning label and the second image data to an artificial intelligence model.

The artificial intelligence model is an occupancy detection model.

The set of instructions further may cause the processor to execute an artificial intelligence model to predict the machine learning label associated with the at least one feature within the image data.

The set of instructions may further cause the processor to receive, from a human reviewer, a validation regarding the machine learning label associated with the at least one feature within the image data predicted by the artificial intelligence model.

The system comprises a set of egos; and a processor in communication with the set of egos, the processor configured to retrieve a set of navigation data and image data from a set of egos navigating within an environment comprising at least one feature; generate a three-dimensional (3D) model of the environment using the navigation data and image data of at least a subset of the set of egos, the 3D model comprising a virtual representation of the at least one feature of the environment; identify a machine learning label associated with the at least one feature within the image data; receive second navigation data and second image data from a second ego not included within the set of egos, the second ego navigating within the environment, the second image data including the at least one feature; and automatically generate a machine learning label for the at least one feature depicted within the second image data.

The processor may be further configured to filter the set of navigation data and image data into a subset of the set of navigation data and image data in accordance with a trajectory of each ego within the set of egos.

The processor may be further configured to localize the second ego using the second navigation data or the second image data in accordance with the 3D model.

The at least one feature is at least one of a drivable surface, a traffic sign, a traffic light, lane lines, or a 3D structure.

### BRIEF DESCRIPTION OF THE DRAWINGS

Non-limiting embodiments of the present disclosure are described by way of example concerning the accompanying figures, which are schematic and are not intended to be drawn to scale. Unless indicated as representing the background art, the figures represent aspects of the disclosure.

FIG. 1A illustrates components of an AI-enabled data analysis system, according to an embodiment.

FIG. 1B illustrates various sensors associated with an ego according to an embodiment.

FIG. 1C illustrates the components of a vehicle, according to an embodiment.

FIG. 2 illustrates a flow diagram of a process executed in an AI-enabled data analysis system, according to an embodiment.

FIG. 3 illustrates data received from an ego, according to an embodiment.

FIG. 4 illustrates a camera feed received from an ego and a corresponding 3D model, according to an embodiment.

FIG. 5 illustrates a 3D model generated by an AI-enabled data analysis system, according to an embodiment.

FIGS. 6-7 illustrate different camera feeds received from one or more egos, according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are to be considered within the scope of the subject matter disclosed herein. Other embodiments may be used and/or other changes may be made without departing from the spirit or scope of the present disclosure. The illustrative embodiments described in the detailed description are not meant to be limiting to the subject matter presented.

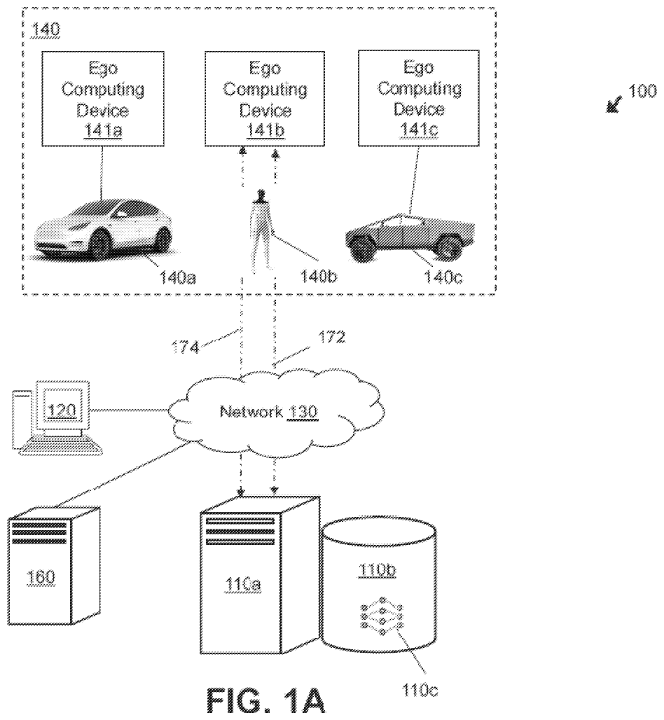

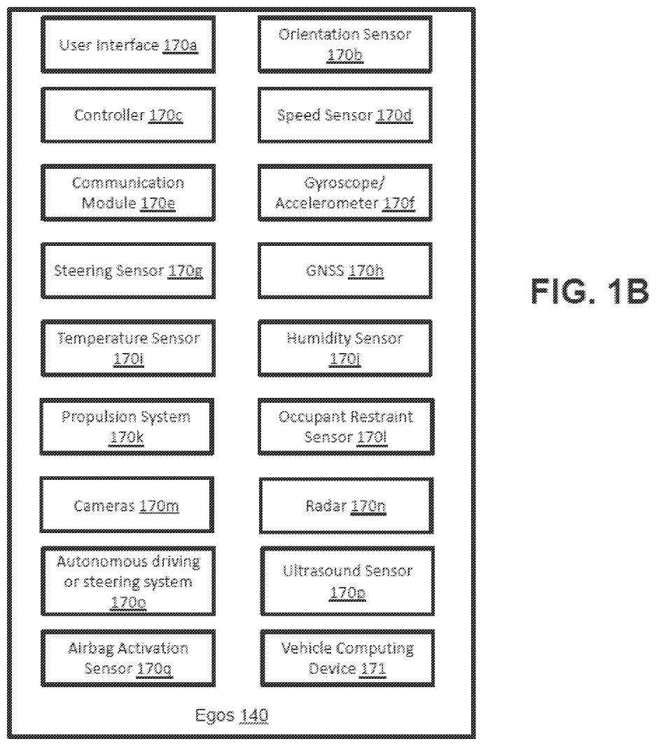

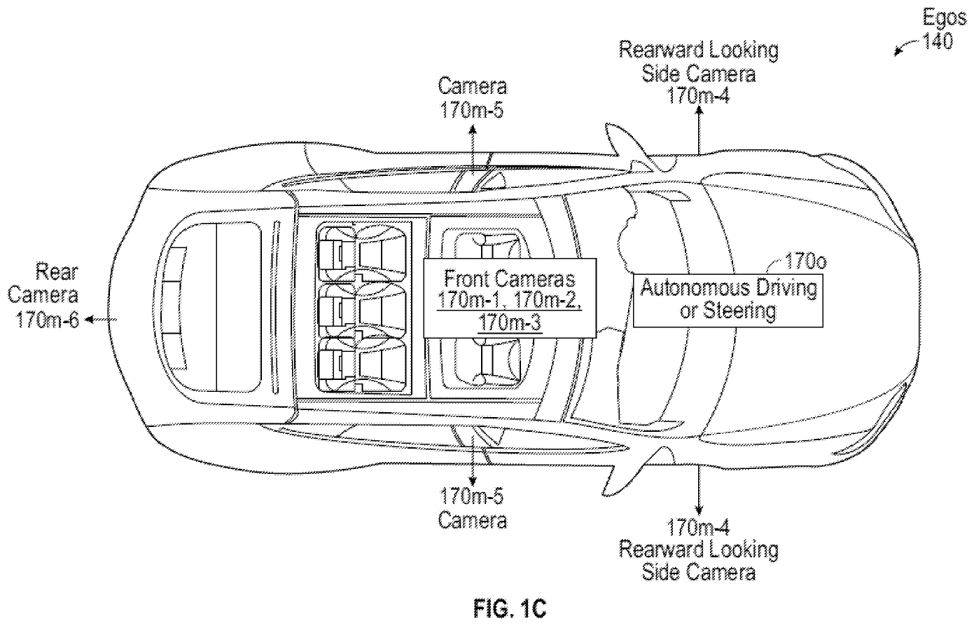

FIG. 1A is a non-limiting example of components of a system in which the methods and systems discussed herein can be implemented. For instance, an analytics server may train an AI model and use the trained AI model to generate an occupancy dataset and/or map for one or more egos. FIG. 1A illustrates components of an AI-enabled data analysis system 100. The system 100 may include an analytics server 110a, a system database 110b, an administrator computing device 120, egos 140a-b (collectively ego(s) 140), ego computing devices 141a-c (collectively ego computing devices 141), and a server 160. The system 100 is not confined to the components described herein and may include additional or other components not shown for brevity, which are to be considered within the scope of the embodiments described herein.

The above-mentioned components may be connected through a network 130. Examples of the network 130 may include, but are not limited to, private or public LAN, WLAN, MAN, WAN, and the Internet. The network 130 may include wired and/or wireless communications according to one or more standards and/or via one or more transport mediums.

The communication over the network 130 may be performed in accordance with various communication protocols such as Transmission Control Protocol and Internet Protocol (TCP/IP), User Datagram Protocol (UDP), and IEEE communication protocols. In one example, the network 130 may include wireless communications according to Bluetooth specification sets or another standard or proprietary wireless communication protocol. In another example, the network 130 may also include communications over a cellular network, including, for example, a GSM (Global System for Mobile Communications), CDMA (Code Division Multiple Access), or an EDGE (Enhanced Data for Global Evolution) network.

The system 100 illustrates an example of a system architecture and components that can be used to train and execute one or more AI models, such the AI model(s) 110c. Specifically, as depicted in FIG. 1A and described herein, the analytics server 110a can use the methods discussed herein to train the AI model(s) 110c using data retrieved from the egos 140 (e.g., by using data streams 172 and 174). When the AI model(s) 110c have been trained, each of the egos 140 may have access to and execute the trained AI model(s) 110c. For instance, the vehicle 140a having the ego computing device 141a may transmit its camera feed to the trained AI model(s) 110c and may determine the occupancy status of its surroundings (e.g., data stream 174). Moreover, the data ingested and/or predicted by the AI model(s) 110c with respect to the egos 140 (at inference time) may also be used to improve the AI model(s) 110c. Therefore, the system 100 depicts a continuous loop that can periodically improve the accuracy of the AI model(s) 110c. Moreover, the system 100 depicts a loop in which data received from the egos 140 can be used in a training phase in addition to the inference phase.

The analytics server 110a may be configured to collect, process, and analyze navigation data (e.g., images captured while navigating) and various sensor data collected from the egos 140. The collected data may then be processed and prepared into a training dataset. The training dataset may then be used to train one or more AI models, such as the AI model 110c. The analytics server 110a may also be configured to collect visual data from the egos 140. Using the AI model 110c (trained using the methods and systems discussed herein), the analytics server 110a may generate a dataset and/or an occupancy map for the egos 140. The analytics server 110a may display the occupancy map on the egos 140 and/or transmit the occupancy map/dataset to the ego computing devices 141, the administrator computing device 120, and/or the server 160.

In FIG. 1A, the AI model 110c is illustrated as a component of the system database 110b, but the AI model 110c may be stored in a different or a separate component, such as cloud storage or any other data repository accessible to the analytics server 110a.

The analytics server 110a may also be configured to display an electronic platform illustrating various training attributes for training the AI model 110c. The electronic platform may be displayed on the administrator computing device 120, such that an analyst can monitor the training of the AI model 110c. An example of the electronic platform generated and hosted by the analytics server 110a may be a web-based application or a website configured to display the training dataset collected from the egos 140 and/or training status/metrics of the AI model 110c.

The analytics server 110a may be any computing device comprising a processor and non-transitory machine-readable storage capable of executing the various tasks and processes described herein. Non-limiting examples of such computing devices may include workstation computers, laptop computers, server computers, and the like. While the system 100 includes a single analytics server 110a, the system 100 may include any number of computing devices operating in a distributed computing environment, such as a cloud environment.

The egos 140 may represent various electronic data sources that transmit data associated with their previous or current navigation sessions to the analytics server 110a. The egos 140 may be any apparatus configured for navigation, such as a vehicle 140a and/or a truck 140c. The egos 140 are not limited to being vehicles and may include robotic devices as well. For instance, the egos 140 may include a robot 140b, which may represent a general purpose, bipedal, autonomous humanoid robot capable of navigating various terrains. The robot 140b may be equipped with software that enables balance, navigation, perception, or interaction with the physical world. The robot 140b may also include various cameras configured to transmit visual data to the analytics server 110a.

Even though referred to herein as an “ego,” the egos 140 may or may not be autonomous devices configured for automatic navigation. For instance, in some embodiments, the ego 140 may be controlled by a human operator or by a remote processor. The ego 140 may include various sensors, such as the sensors depicted in FIG. 1B. The sensors may be configured to collect data as the egos 140 navigate various terrains (e.g., roads). The analytics server 110a may collect data provided by the egos 140. For instance, the analytics server 110a may obtain navigation session and/or road/terrain data (e.g., images of the egos 140 navigating roads) from various sensors, such that the collected data is eventually used by the AI model 110c for training purposes.

As used herein, a navigation session corresponds to a trip where egos 140 travel a route, regardless of whether the trip was autonomous or controlled by a human. In some embodiments, the navigation session may be for data collection and model training purposes. However, in some other embodiments, the egos 140 may refer to a vehicle purchased by a consumer and the purpose of the trip may be categorized as everyday use. The navigation session may start when the egos 140 move from a non-moving position beyond a threshold distance (e.g., 0.1 miles, 100 feet) or exceed a threshold speed (e.g., over 0 mph, over 1 mph, over 5 mph). The navigation session may end when the egos 140 are returned to a non-moving position and/or are turned off (e.g. when a driver exits a vehicle).

The egos 140 may represent a collection of egos monitored by the analytics server 110a to train the AI model(s) 110c. For instance, a driver for the vehicle 140a may authorize the analytics server 110a to monitor data associated with their respective vehicle. As a result, the analytics server 110a may utilize various methods discussed herein to collect sensor/camera data and generate a training dataset to train the AI model(s) 110c accordingly. The analytics server 110a may then apply the trained AI model(s) 110c to analyze data associated with the egos 140 and to predict an occupancy map for the egos 140. Moreover, additional/ongoing data associated with the egos 140 can also be processed and added to the training dataset, such that the analytics server 110a re-calibrates the AI model(s) 110c accordingly. Therefore, the system 100 depicts a loop in which navigation data received from the egos 140 can be used to train the AI model(s) 110c. The egos 140 may include processors that execute the trained AI model(s) 110c for navigational purposes. While navigating, the egos 140 can collect additional data regarding their navigation sessions, and the additional data can be used to calibrate the AI model(s) 110c. That is, the egos 140 represent egos that can be used to train, execute/use, and re-calibrate the AI model(s) 110c. In a non-limiting example, the egos 140 represent vehicles purchased by customers that can use the AI model(s) 110c to autonomously navigate while simultaneously improving the AI model(s) 110c.

The egos 140 may be equipped with various technology allowing the egos to collect data from their surroundings and (possibly) navigate autonomously. For instance, the egos 140 may be equipped with inference chips to run self-driving software.

Various sensors for each ego 140 may monitor and transmit the collected data associated with different navigation sessions to the analytics server 110a. FIGS. 1B-C illustrate block diagrams of sensors integrated within the egos 140, according to an embodiment. The number and position of each sensor discussed with respect to FIGS. 1B-C may depend on the type of ego discussed in FIG. 1A. For instance, the robot 140b may include different sensors than the vehicle 140a or the truck 140c. For instance, the robot 140b may not include the airbag activation sensor 170q. Moreover, the sensors of the vehicle 140a and the truck 140c may be positioned differently than illustrated in FIG. 1C.

As discussed herein, various sensors integrated within each ego 140 may be configured to measure various data associated with each navigation session. The analytics server 110a may periodically collect data monitored and collected by these sensors, wherein the data is processed in accordance with the methods described herein and used to train the AI model 110c and/or execute the AI model 110c to generate the occupancy map.

The egos 140 may include a user interface 170a. The user interface 170a may refer to a user interface of an ego computing device (e.g., the ego computing devices 141 in FIG. 1A). The user interface 170a may be implemented as a display screen integrated with or coupled to the interior of a vehicle, a heads-up display, a touchscreen, or the like. The user interface 170a may include an input device, such as a touchscreen, knobs, buttons, a keyboard, a mouse, a gesture sensor, a steering wheel, or the like. In various embodiments, the user interface 170a may be adapted to provide user input (e.g., as a type of signal and/or sensor information) to other devices or sensors of the egos 140 (e.g., sensors illustrated in FIG. 1B), such as a controller 170c.

The user interface 170a may also be implemented with one or more logic devices that may be adapted to execute instructions, such as software instructions, implementing any of the various processes and/or methods described herein. For example, the user interface 170a may be adapted to form communication links, transmit and/or receive communications (e.g., sensor signals, control signals, sensor information, user input, and/or other information), or perform various other processes and/or methods. In another example, the driver may use the user interface 170a to control the temperature of the egos 140 or activate its features (e.g., autonomous driving or steering system 1700). Therefore, the user interface 170a may monitor and collect driving session data in conjunction with other sensors described herein. The user interface 170a may also be configured to display various data generated/predicted by the analytics server 110a and/or the AI model 110c.

An orientation sensor 170b may be implemented as one or more of a compass, float, accelerometer, and/or other digital or analog device capable of measuring the orientation of the egos 140 (e.g., magnitude and direction of roll, pitch, and/or yaw, relative to one or more reference orientations such as gravity and/or magnetic north). The orientation sensor 170b may be adapted to provide heading measurements for the egos 140. In other embodiments, the orientation sensor 170b may be adapted to provide roll, pitch, and/or yaw rates for the egos 140 using a time series of orientation measurements. The orientation sensor 170b may be positioned and/or adapted to make orientation measurements in relation to a particular coordinate frame of the egos 140.

A controller 170c may be implemented as any appropriate logic device (e.g., processing device, microcontroller, processor, application-specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the egos 140. Such software instructions may also implement methods for processing sensor signals, determining sensor information, providing user feedback (e.g., through user interface 170a), querying devices for operational parameters, selecting operational parameters for devices, or performing any of the various operations described herein.

A communication module 170e may be implemented as any wired and/or wireless interface configured to communicate sensor data, configuration data, parameters, and/or other data and/or signals to any feature shown in FIG. 1A (e.g., analytics server 110a). As described herein, in some embodiments, communication module 170e may be implemented in a distributed manner such that portions of communication module 170e are implemented within one or more elements and sensors shown in FIG. 1B. In some embodiments, the communication module 170e may delay communicating sensor data. For instance, when the egos 140 do not have network connectivity, the communication module 170e may store sensor data within temporary data storage and transmit the sensor data when the egos 140 are identified as having proper network connectivity.

A speed sensor 170d may be implemented as an electronic pitot tube, metered gear or wheel, water speed sensor, wind speed sensor, wind velocity sensor (e.g., direction and magnitude), and/or other devices capable of measuring or determining a linear speed of the egos 140 (e.g., in a surrounding medium and/or aligned with a longitudinal axis of the egos 140) and providing such measurements as sensor signals that may be communicated to various devices.

A gyroscope/accelerometer 170f may be implemented as one or more electronic sextants, semiconductor devices, integrated chips, accelerometer sensors, or other systems or devices capable of measuring angular velocities/accelerations and/or linear accelerations (e.g., direction and magnitude) of the egos 140, and providing such measurements as sensor signals that may be communicated to other devices, such as the analytics server 110a. The gyroscope/accelerometer 170f may be positioned and/or adapted to make such measurements in relation to a particular coordinate frame of the egos 140. In various embodiments, the gyroscope/accelerometer 170f may be implemented in a common housing and/or module with other elements depicted in FIG. 1B to ensure a common reference frame or a known transformation between reference frames.

A global navigation satellite system (GNSS) 170h may be implemented as a global positioning satellite receiver and/or another device capable of determining absolute and/or relative positions of the egos 140 based on wireless signals received from space-born and/or terrestrial sources, for example, and capable of providing such measurements as sensor signals that may be communicated to various devices. In some embodiments, the GNSS 170h may be adapted to determine the velocity, speed, and/or yaw rate of the egos 140 (e.g., using a time series of position measurements), such as an absolute velocity and/or a yaw component of an angular velocity of the egos 140.

A temperature sensor 170i may be implemented as a thermistor, electrical sensor, electrical thermometer, and/or other devices capable of measuring temperatures associated with the egos 140 and providing such measurements as sensor signals. The temperature sensor 170i may be configured to measure an environmental temperature associated with the egos 140, such as a cockpit or dash temperature, for example, which may be used to estimate a temperature of one or more elements of the egos 140.

A humidity sensor 170j may be implemented as a relative humidity sensor, electrical sensor, electrical relative humidity sensor, and/or another device capable of measuring a relative humidity associated with the egos 140 and providing such measurements as sensor signals.

A steering sensor 170g may be adapted to physically adjust a heading of the egos 140 according to one or more control signals and/or user inputs provided by a logic device, such as controller 170c. Steering sensor 170g may include one or more actuators and control surfaces (e.g., a rudder or other type of steering or trim mechanism) of the egos 140, and may be adapted to physically adjust the control surfaces to a variety of positive and/or negative steering angles/positions. The steering sensor 170g may also be adapted to sense a current steering angle/position of such steering mechanism and provide such measurements.

A propulsion system 170k may be implemented as a propeller, turbine, or other thrust-based propulsion system, a mechanical wheeled and/or tracked propulsion system, a wind/sail-based propulsion system, and/or other types of propulsion systems that can be used to provide motive force to the egos 140. The propulsion system 170k may also monitor the direction of the motive force and/or thrust of the egos 140 relative to a coordinate frame of reference of the egos 140. In some embodiments, the propulsion system 170k may be coupled to and/or integrated with the steering sensor 170g.

An occupant restraint sensor 1701 may monitor seatbelt detection and locking/unlocking assemblies, as well as other passenger restraint subsystems. The occupant restraint sensor 1701 may include various environmental and/or status sensors, actuators, and/or other devices facilitating the operation of safety mechanisms associated with the operation of the egos 140. For example, occupant restraint sensor 1701 may be configured to receive motion and/or status data from other sensors depicted in FIG. 1B. The occupant restraint sensor 1701 may determine whether safety measurements (e.g., seatbelts) are being used.

Cameras 170m may refer to one or more cameras integrated within the egos 140 and may include multiple cameras integrated (or retrofitted) into the ego 140, as depicted in FIG. 1C. The cameras 170m may be interior-or exterior-facing cameras of the egos 140. For instance, as depicted in FIG. 1C, the egos 140 may include one or more interior-facing cameras that may monitor and collect footage of the occupants of the egos 140. The egos 140 may include eight exterior-facing cameras. For example, the egos 140 may include a front camera 170m-1, a forward-looking side camera 170m-2, a forward-looking side camera 170m-3, a rearward looking side camera 170m-4 on each front fender, a camera 170m-5 (e.g., integrated within a B-pillar) on each side, and a rear camera 170m-6.

Referring to FIG. 1B, a radar 170n and ultrasound sensors 170p may be configured to monitor the distance of the egos 140 to other objects, such as other vehicles or immobile objects (e.g., trees or garage doors). The egos 140 may also include an autonomous driving or steering system 1700 configured to use data collected via various sensors (e.g., radar 170n, speed sensor 170d, and/or ultrasound sensors 170p) to autonomously navigate the ego 140.

Therefore, autonomous driving or steering system 1700 may analyze various data collected by one or more sensors described herein to identify driving data. For instance, autonomous driving or steering system 1700 may calculate a risk of forward collision based on the speed of the ego 140 and its distance to another vehicle on the road. The autonomous driving or steering system 1700 may also determine whether the driver is touching the steering wheel. The autonomous driving or steering system 1700 may transmit the analyzed data to various features discussed herein, such as the analytics server.

An airbag activation sensor 170q may anticipate or detect a collision and cause the activation or deployment of one or more airbags. The airbag activation sensor 170q may transmit data regarding the deployment of an airbag, including data associated with the event causing the deployment.

Referring back to FIG. 1A, the administrator computing device 120 may represent a computing device operated by a system administrator. The administrator computing device 120 may be configured to display data retrieved or generated by the analytics server 110a (e.g., various analytic metrics and risk scores), wherein the system administrator can monitor various models utilized by the analytics server 110a, review feedback, and/or facilitate the training of the AI model(s) 110c maintained by the analytics server 110a.

The ego(s) 140 may be any device configured to navigate various routes, such as the vehicle 140a or the robot 140b. As discussed with respect to FIGS. 1B-C, the ego 140 may include various telemetry sensors. The egos 140 may also include ego computing devices 141. Specifically, each ego may have its own ego computing device 141. For instance, the truck 140c may have the ego computing device 141c. For brevity, the ego computing devices are collectively referred to as the ego computing device(s) 141. The ego computing devices 141 may control the presentation of content on an infotainment system of the egos 140, process commands associated with the infotainment system, aggregate sensor data, manage communication of data to an electronic data source, receive updates, and/or transmit messages. In one configuration, the ego computing device 141 communicates with an electronic control unit. In another configuration, the ego computing device 141 is an electronic control unit. The ego computing devices 141 may comprise a processor and a non-transitory machine-readable storage medium capable of performing the various tasks and processes described herein. For example, the AI model(s) 110c described herein may be stored and performed (or directly accessed) by the ego computing devices 141. Non-limiting examples of the ego computing devices 141 may include a vehicle multimedia and/or display system.

In one example of how the AI model(s) 110c can be trained, the analytics server 110a may collect data from egos 140 to train the AI model(s) 110c. Before executing the AI model(s) 110c to generate/predict an occupancy dataset, the analytics server 110a may train the AI model (s) 110c using various methods. The training allows the AI model(s) 110c to ingest data from one or more cameras of one or more egos 140 (without the need to receive radar data) and predict occupancy data for the ego's surroundings. The operation described in this example may be executed by any number of computing devices operating in the distributed computing system described in FIGS. 1A and 1B (e.g., a processor of the egos 140.

To train the AI model(s) 110c, the analytics server 110a may communicate with one or more of the egos 140 driving a particular route. For instance, one or more egos may be selected for training purposes. The one or more egos may drive the particular route autonomously or via a human operator. As a result of the one or more egos navigating, various data points may be collected and used for training purposes. For instance, while driving, the egos 140 may use one or more of their sensors (including one or more cameras) to generate navigation session data. For instance, the one or more of the egos 140 equipped with various sensors can navigate the designated route. As the one or more of the egos 140 traverse the terrain, their sensors may capture continuous (or periodic) data of their surroundings. The sensors may indicate an occupancy status of the one or more egos'140 surroundings. For instance, the sensor data may indicate various objects having mass in the surroundings of the one or more of the egos 140 as they navigate their route.

The analytics server 110a may generate a training dataset using data collected from the egos 140 (e.g., camera feed received from the egos 140). The training dataset may indicate the occupancy status of different voxels within the surroundings of the one or more of the egos 140. As used herein in some embodiments, a voxel is a three-dimensional pixel, forming a building block of the surroundings of the one or more of the egos 140. Within the training dataset, each voxel may encapsulate sensor data indicating whether a mass was identified for that particular voxel. Mass, as used herein, may indicate or represent any object identified using the sensor. For instance, in some embodiments, the egos 140 may be equipped with sensors that can identify masses near the egos 140.

In some embodiments, the training dataset may include data received from a camera of the egos 140. The data received from the camera(s) may have a set of data points where each data point corresponds to a location and an image attribute of at least one voxel of space around the ego 140. The training dataset may also include 3D geometry data to indicate whether a voxel of the one or more egos 140 surroundings is occupied by an object having mass or not.

In operation, as the one or more egos 140 navigate, their sensors collect data and transmit the data to the analytics server 110a, as depicted in the data stream 172.

In some embodiments, the one or more egos 140 may include one or more high-resolution cameras that capture a continuous stream of visual data from the surroundings of the one or more egos 140 as the one or more egos 140 navigate through the route. The analytics server 110a may then generate a second dataset using the camera feed where visual elements/depictions of different voxels of the one or more egos'140 surroundings are included within the second dataset.

In operation, as the one or more egos 140 navigate, their cameras collect data and transmit the data to the analytics server 110a, as depicted in the data stream 172. For instance, the ego computing devices 141 may transmit image data to the analytics server 110a using the data stream 172.

The analytics server 110a may train an AI model using the first and second datasets, whereby the AI model 110c correlates each data point within the first set of data points with a corresponding data point within the second set of data points, using each data point's respective location to train itself, wherein, once trained, the AI model 110c is configured to receive a camera feed from a new ego 140 and predict an occupancy status of at least one voxel of the camera feed.

Using the first and second datasets, the analytics server 110a may train the AI model(s) 110c, such that the AI model(s) 110c may correlate different visual attributes of a voxel (within the camera feed within the second dataset) to an occupancy status of that voxel (within the first dataset). In this way, once trained, the AI model(s) 110c may receive a camera feed (e.g., from a new ego 140) without receiving sensor data and then determine each voxel's occupancy status for the new ego 140.

The analytics server 110a may generate a training dataset that includes the first and second datasets. The analytics server 110a may use the first dataset as ground truth. For instance, the first dataset may indicate the different location of voxels and their occupancy status. The second dataset may include a visual (e.g., a camera feed) illustration of the same voxel. Using the first dataset, the analytics server 110a may label the data, such that data record(s) associated with each voxel corresponding to an object are indicated as having a positive occupancy status.

The labeling of the occupancy status of different voxels may be performed automatically and/or manually. For instance, in some embodiments, the analytics server 110a may use human reviewers to label the data. For instance, as discussed herein, the camera feed from one or more cameras of a vehicle may be shown on an electronic platform to a human reviewer for labeling. Additionally or alternatively, the data in its entirety may be ingested by the AI model(s) 110c where the AI model(s) 110c identifies corresponding voxels, analyzes the first digital map, and correlates the image(s) of each voxel to its respective occupancy status.

Using the methods and systems discussed herein, the analytics server 110a may automatically label the data, such that the training process for the AI model(s) 110c is more efficiently performed.

Using the ground truth, the AI model(s) 110c may be trained, such that each voxel's visual elements are analyzed and correlated to whether that voxel was occupied by a mass. Therefore, the AI model 110c may retrieve the occupancy status of each voxel (using the first dataset) and use the information as ground truth. The AI model(s) 110c may also retrieve visual attributes of the same voxel using the second dataset.

In some embodiments, the analytics server 110a may use a supervised method of training. For instance, using the ground truth and the visual data received, the AI model(s) 110c may train itself, such that it can predict an occupancy status for a voxel using only an image of that voxel. As a result, when trained, the AI model(s) 110c may receive a camera feed, analyze the camera feed, and determine an occupancy status for each voxel within the camera feed (without the need to use a radar).

The analytics server 110a may feed the series of training datasets to the AI model(s) 110c and obtain a set of predicted outputs (e.g., predicted occupancy status). The analytics server 110a may then compare the predicted data with the ground truth data to determine a difference and train the AI model(s) 110c by adjusting the AI model's 110c internal weights and parameters proportional to the determined difference according to a loss function. The analytics server 110a may train the AI model(s) 110c in a similar manner until the trained AI model's 110c prediction is accurate to a certain threshold (e.g., recall or precision).

Additionally or alternatively, the analytics server 110a may use an unsupervised method where the training dataset is not labeled. Because labeling the data within the training dataset may be time-consuming and may require excessive computing power, the analytics server 110a may utilize unsupervised training techniques to train the AI model 110c. In some embodiments, instead of an unsupervised method, the analytics server 110a may utilize the methods discussed herein to automatically label the data.

After the AI model 110c is trained, it can be used by an ego 140 to predict occupancy data of the one or more egos'140 surroundings. For instance, the AI model(s) 110c may divide the ego's surroundings into different voxels and predict an occupancy status for each voxel. In some embodiments, the AI model(s) 110c (or the analytics server 110a using the data predicted using the AI model 110c) may generate an occupancy map or occupancy network representing the surroundings of the one or more egos 140 at any given time.

In another example of how the AI model(s) 110c may be used, after training the AI model(s) 110c, analytics server 110a (or a local chip of an ego 140) may collect data from an ego (e.g., one or more of the egos 140) to predict an occupancy dataset for the one or more egos 140. This example describes how the AI model(s) 110c can be used to predict occupancy data in real-time or near real-time for one or more egos 140. This configuration may have a processor, such as the analytics server 110a, execute the AI model. However, one or more actions may be performed locally via, for example, a chip located within the one or more egos 140. In operation, the AI model(s) 110c may be executed via an ego 140 locally, such that the results can be used to autonomously navigate itself.

The processor may input, using a camera of an ego object 140, image data of a space around the ego object 140 into an AI model 110c. The processor may collect and/or analyze data received from various cameras of one or more egos 140 (e.g., exterior-facing cameras). In another example, the processor may collect and aggregate footage recorded by one or more cameras of the egos 140. The processor may then transmit the footage to the AI model(s) 110c trained using the methods discussed herein.

The processor may predict, by executing the AI model 110c, an occupancy attribute of a plurality of voxels. The AI model(s) 110c may use the methods discussed herein to predict an occupancy status for different voxels surrounding the one or more egos 140 using the image data received.

The processor may generate a dataset based on the plurality of voxels and their corresponding occupancy attribute. The analytics server 110a may generate a dataset that includes the occupancy status of different voxels in accordance with their respective coordinate values. The dataset may be a query-able dataset available to transmit the predicted occupancy status to different software modules.

In operation, the one or more egos 140 may collect image data from their cameras and transmit the image data to the processor (placed locally on the one or more egos 140) and/or the analytics server 110a, as depicted in the data stream 172. The processor may then execute the AI model(s) 110c to predict occupancy data for the one or more egos 140. If the prediction is performed by the analytics server 110a, then the occupancy data can be transmitted to the one or more egos 140 using the data stream 174. If the processor is placed locally within the one or more egos 140, then the occupancy data is transmitted to the ego computing devices 141 (not shown in FIG. 1A).

Using the methods discussed herein, the training of the AI model(s) 110c can be performed such that the execution of the AI model(s) 110c may be performed locally on any of the egos 140 (at inference time). The data collected (e.g., navigational data collected during the navigation of the egos 140, such as image data of a trip) can then be fed back into the AI model(s) 110c, such that the additional data can improve the AI model(s) 110c.

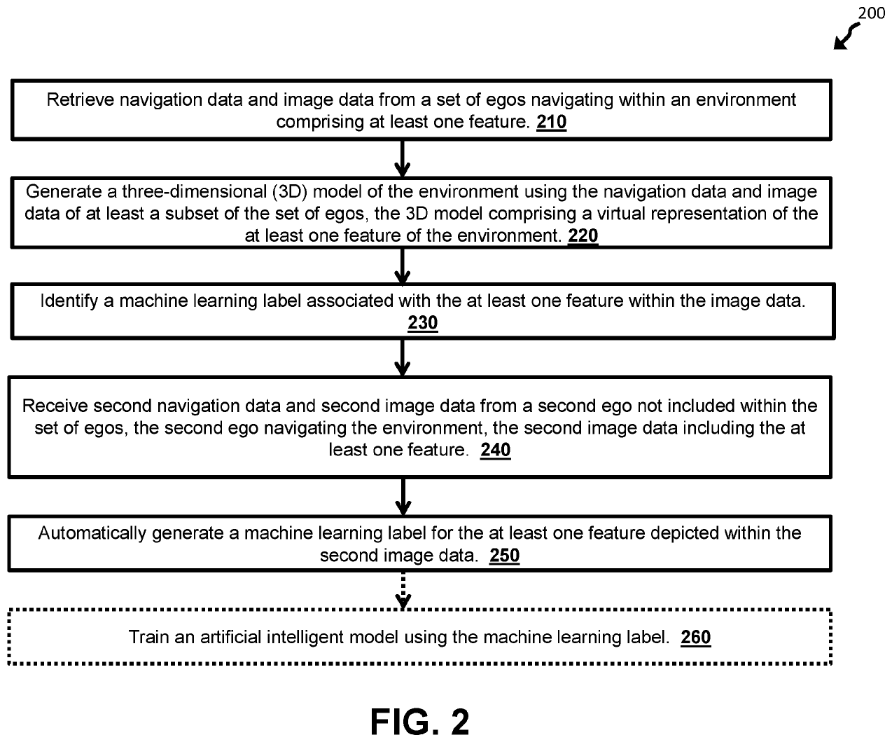

FIG. 2 illustrates a flow diagram of a method 200 executed in an AI-enabled, visual data analysis system, according to an embodiment. The method 200 may include steps 210-270. However, other embodiments may include additional or alternative steps or may omit one or more steps. The method 200 is executed by an analytics server (e.g., a computer similar to the analytics server 110a). However, one or more steps of the method 200 may be executed by any number of computing devices operating in the distributed computing system described in FIGS. 1A-C (e.g., a processor of the ego 140 and/or ego computing devices 141). For instance, one or more computing devices of an ego may locally perform some or all steps described in FIG. 2.

Using the methods discussed herein, the analytics server 110a may collect data from the egos 140 and generate an initial inference indicating an initial label for various features included within the data. For instance, the analytics server may collect a camera feed of each ego and determine an indication of various features depicted within the camera feed (e.g., trees, buildings, traffic lights, or traffic signs). The initial inference may be displayed on a platform where a human reviewer can confirm/validate the initial inference in light of reviewing the camera footage received. When the initial inference is validated, the analytics server 110a can automatically label new footage received from the egos 140. The labeled data may then be transmitted to the AI model(s) 110c.

FIG. 2 illustrates a flowchart of a method that can be used to automatically label data to train one or more artificial intelligence models, such as the AI model(s) 110c. Using the methods and systems discussed herein, the analytics server may ingest image data (e.g., camera feed from an ego's surroundings) and automatically label various features depicted within the camera feed with little to non-human intervention.

The method 200 is described as being executed by the analytics server. However, one or more of the steps of the method 200 may be performed by other processors. For instance, the step 210 may be locally performed by an ego computing device. Then, other steps may be performed by a central processor (e.g., in the cloud).

At step 210, the analytics server may retrieve navigation data and image data from a set of egos navigating within an environment comprising at least one feature. The analytics server may be in communication with an ego computing device. As discussed herein, the ego computing device may communicate with various sensors of an ego and collect sensor data. The ego computing device may then transmit the sensor data to the analytics server.

As used herein, navigation data may include any data that is collected and/or retrieved by an ego in relation to its navigation of an environment (whether autonomously or via a human operator). As discussed herein, egos may rely on various sensors and technologies to gather comprehensive navigation data, enabling them to autonomously navigate through/within various environments. Therefore, the egos may collect a diverse range of information from the environment within which they navigate. Accordingly, the navigation data may include any data collected by any of the sensors discussed in FIGS. 1A-C. Additionally, navigation data may include any data extracted or analyzed using any of the sensor data, including high-definition maps, trajectory information, and the like. Non-limiting examples of navigation data may include visual inertial odometry (VIO), inertial measurement unit (IMU) data, and/or any data that can indicate a location and trajectory of the ego.

In some embodiments, the navigation data may be anonymized. Therefore, the analytics server may not receive an indication of which dataset/data point belongs to which ego within the set of egos. The anonymization may be performed locally on the ego, e.g., via the ego computing device. Alternatively, the anonymization may be performed by another processor before the data is received by the analytics server.

In some embodiments, an ego processor/computing device may only transmit strings of data without any ego identification data that would allow the analytics server and/or any other processor to determine which ego has produced which dataset. As a result, the analytics server may simply receive image data (camera feed) of an ego along with VIO data, and IMU data captured by one or more sensors of the ego.

The analytics server may be in communication with a processor of each ego within a set of egos navigating within various environments. The analytics server may then collect navigation data (in real-time, near real-time, or at various other frequencies) from the set of egos.

In addition to retrieving navigation data, the analytics server may retrieve image data (e.g., camera feed or video clips) of the set of ego as they navigate within different environments. The image data may include various features located within the environment. As used herein, a feature within an environment may refer to any physical item that is located in an environment within which one or more egos navigate. Therefore, a feature may correspond to natural or man-made objects whether traffic-related or not. Non-limiting examples of features may include lane lines or other traffic markings, road/traffic signs, traffic lights, sidewalk markings, buildings, and the like.

The analytics server may then aggregate the data and pre-process the data (e.g., de-duplicate the data and/or de-noise the data). Additionally, the analytics server may analyze the raw data received to identify one or more attributes of the navigation itself. For instance, navigation data can be analyzed to determine the trajectory of an ego. As described herein, the aggregated data may be used to generate a 3D model of the environment itself.

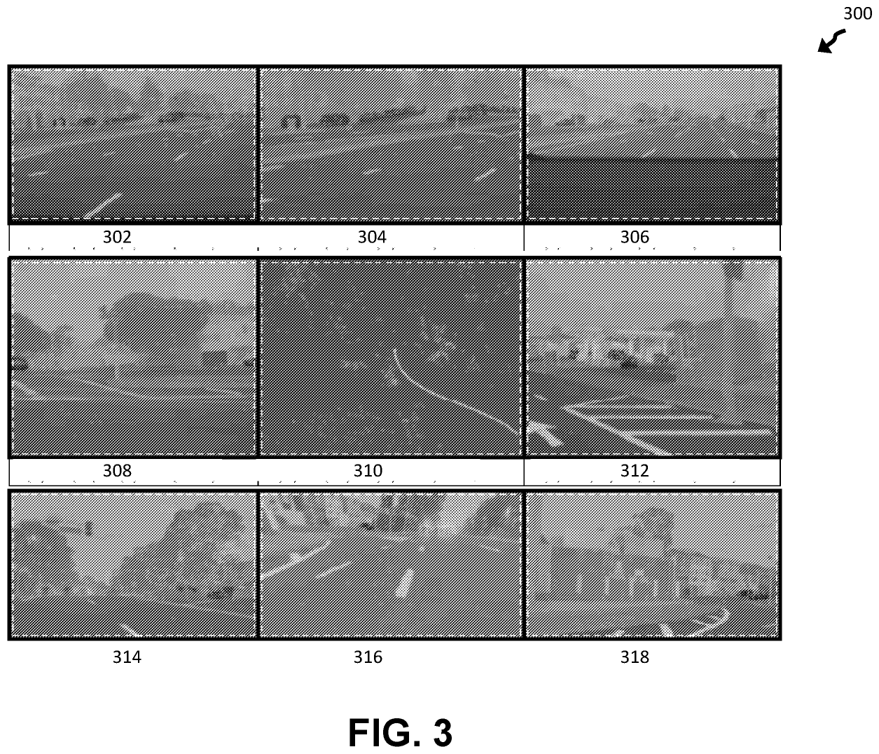

Referring now to FIG. 3, the data 300 visually represents navigational and image data retrieved from an ego while the ego is navigating within an environment. The data 300 may include image data 302, 304, 306, 308, 312, 314, 316, and 318 (collectively the camera feed 301). The camera feed 301 may include image data captured by each of the ego's eight cameras as depicted in FIG. 1C. Therefore, as the ego navigates through an environment, eight different cameras collect image data of the ego's surroundings (e.g., the environment). The camera feed 301 may depict various features located within the environment. For instance, the image data 302 depicts various lane lines (e.g., dashed lines dividing four lanes) and trees. The image data 304 depicts the same lane lines and trees from a different angle. The image data 306 depicts the same lane lines from yet another angle. Additionally, the image 306 also depicts buildings on the other side of the street. The image data 308, 312, 318, 316, and 314 depict the same lane lines. However, some of these image data also depict additional features, such as the traffic light depicted in the image data 314, 308, and/or 312.

The navigational data 310 represents a trajectory of the ego from which the image data is depicted within FIG. 3 has been collected. The trajectory may be a two or three-dimensional trajectory of the ego that has been calculated using sensor data retrieved from the go. In some embodiments, various navigational data may be used to determine the trajectory of the ego.

As discussed therein, the ego may be equipped with various location-tracking data. Using this data, a processor of the ego and/or the analytics server may generate a trajectory for the travel path of the ego. Each image within the camera feed 301 may also include a timestamp that may correspond to a timestamp of the egos trajectory as calculated and depicted within the navigational data 310. Therefore, the analytics server may identify up to eight images from different cameras of the ego at each timestamp and location within the ego's navigation within the environment.

Referring back to FIG. 2, at step 220, the analytics server may generate a three-dimensional (3D) model of the environment using the navigation data and image data of at least a subset of the set of egos, the 3D model comprising a virtual representation of the at least one feature of the environment.

The analytics server may generate a 3D model of the environment using the data retrieved in the step 210. The analytics server may first filter the navigation data and image data using the location/trajectory of each ego, such that the data retrieved is limited to a particular environment. The analytics server may then generate a 3D model of the environment. Each location within the 3D model may correspond to one or more images (or videos) of that location within the environment that has been captured from a camera of one or more egos.

The 3D model may resemble a high-definition map that includes various features depicted from the data retrieved in the step 210. Before generating the 3D model, the analytics server may execute one or more computer modeling techniques to identify various features of the environment, such as road surfaces, objects, traffic features, and the like. For instance, using the navigational data and the camera feed received from the set of egos, the analytics server may execute an occupancy or a surface network to determine the occupancy status of various parcels within the environments. The analytics server may also execute various semantic analytical protocols, image segmentation protocols, object recognition protocols, and various other modeling techniques to recognize various features located within the environments, such as buildings, lane markings, traffic lights, road signs, and the like.

The ego computing device and/or the analytics server may be equipped with a VIO system that can retrieve the 3D trajectory of the ego and each camera within each ego. Using this data, the analytics server may generate a (sometimes sparse) 3D structure as it is captured by each camera (e.g., from the point of view of each camera). The analytics server may also generate a full 3D (e.g., six degrees of freedom accounting for rotation and translation) using the camera feed and the trajectory of the ego. Once that data is retrieved from the ego and/or generated by the analytics server, the analytics server may identify multiple drives or navigation sessions (and their corresponding data) from similar environments (e.g., multiple egos navigating through the same neighborhood).

The analytics server may then use the data associated with different navigation sessions (VIO, odometry, and other data) to group similar navigation data. For instance, the analytics server may use the image data retrieved and cluster various navigation sessions (camera feeds of various trips) based on their similarity (e.g., navigations within the same environment). The analytics server may then align the image data from different egos within the same cluster of trips. That is, the 3D model generated based on each ego within the cluster may be aligned with other 3D models generated by other egos navigating within the same environment. Using all the image data, the analytics server may recreate a 3D representation of the environment, which is referred to herein as the 3D model. The 3D model may also include a mesh surface representation of the driving surface along with a representation of various vertical structures/features, such as buildings or signs.

In order to generate the 3D model, the analytics server may first filter through various image data (navigation clips or camera feed) received from the different egos. Even within a cluster of egos and/or a cluster of navigations, the analytics server may identify and eliminate overlapping image data. In this way, redundancies are eliminated. The analytics server may filter the image data to non-overlapping clips of navigations. For instance, if two video clips of driving through the same street and within the same lane are identified, the analytics server may only use one of the video clips when generating the 3D model.

After the image data has been filtered, the analytics server may execute a coarse alignment protocol. The analytics server may use VIO data associated with image data of different egos to find similarities among different image features. Once a shared feature in two video clips is identified, the shared feature can be used to perform some initial visual alignments of the two video clips. This alignment may be coarse because it provides a preliminary alignment of the environment navigated by the two egos.

After the initial alignment of video clips, the analytics server may identify various video clips that have one feature in common. For instance, the analytics server may identify ten navigation sessions that involved (passed over) a particular crosswalk. The trips may not originate from the same location and may not share the same destination. However, at least a part of the trips can be used because those portions share data from the same environment. That is, the camera feeds of the trips include the same feature (crosswalk).

Once navigation sessions that are aligned are identified, the analytics server may execute a pairwise matching protocol. The analytics server may then compare the trips that have been coarsely aligned and determine additional features that are common within each ego's captured data. For instance, the analytics server may compare different frames of camera feeds for each of two coarsely aligned trips, such that the analytics server can identify matching features. The analytics server may identify key points within the image data captured from each trip (e.g., image data with unique and distinctive texture) and try to match the key point within a frame captured by a camera of a first ego with another key point within a frame captured by a camera of a second ego. The pairwise matching protocol allows the analytics server to rectify camera feeds from different egos that capture images of the same feature (e.g., the same traffic light) but from different angles. While the images may not seem similar to each other (because they are captured from different angles), they may share key points that can be matched.

The analytics server may then execute various optimization protocols. In some embodiments, the analytics server may execute a pose-graph optimization protocol. The analytics server may optimize the trajectory for different trips using the pose-graph optimization protocol.

In some embodiments, the trajectory of two egos may not match because each navigation session is different. As a result, the 3D structure viewed by each ego is slightly different (even though they are views of the same structure). The optimization protocol performed by the analytics server reduces/minimizes these differences. When the six degrees of freedom pose of the camera is adjusted, the analytics server may determine a projection of the features near the ego. For instance, how a building is depicted within an image may change (after the adjustment). During optimization, this change can be minimized/reduced. Via optimizing, the analytics server may use different camera feeds from different egos captured by cameras pointing at slightly different directions, as long as each camera feed includes the same key feature of the same object within the physical environment. As a result, a 3D model of the object can be generated using the aggregated camera feeds. In some embodiments, the analytics server may use a large-scale non-linear least square optimization protocol.

In some embodiments, by adjusting the 3D pose of each camera, the analytics server can align the rays for the cameras. As used herein, a ray refers to a beam shot from the center of a camera going through the detected (or viewed) point. Camera rays can be moved by adjusting the 3D pose of the camera. The analytics server may identify all rays that include a corresponding 3D point. For instance, a feature of the environment (e.g., traffic light) can be selected and all camera rays that pointed (at some point) towards the traffic light can be identified and their respective rays can be adjusted and optimized, such that the 3D coordinates of the traffic light are determined.

In some embodiments, the analytics server may perform a bundle adjustment protocol to optimize the 3D pose of each camera and the 3D positions of key features common within the image data received from different egos.

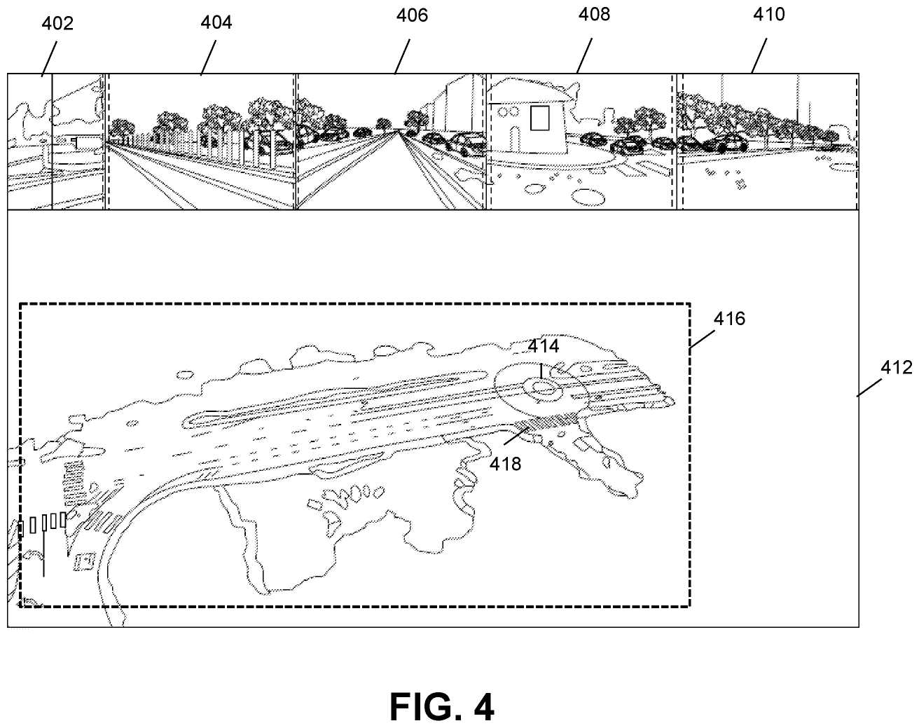

Referring now to FIG. 4, a non-limiting example of a 3D model and its corresponding camera feed is illustrated. As depicted, the image data 402-410 represents a camera feed captured by a camera of an ego navigating within a street. Using the camera feed in conjunction with other navigational data received from the ego, the analytics server may generate the 3D model 412. The 3D model 412 may indicate a location of the ego (414) driving thought the environment 416. The environment 416 may be a 3D representation that includes features captured as a result of analyzing the camera feed and navigational data of the ego. Therefore, the environment 416 resembles the environment within which the ego navigates. For instance, the sidewalk 418 corresponds to the sidewalk seen in the image data 408. The model 412 may include all the features identified within the environment, such as traffic lights, road signs, and the like. Additionally, the model 412 may include a mesh surface for the street on which the ego navigates.

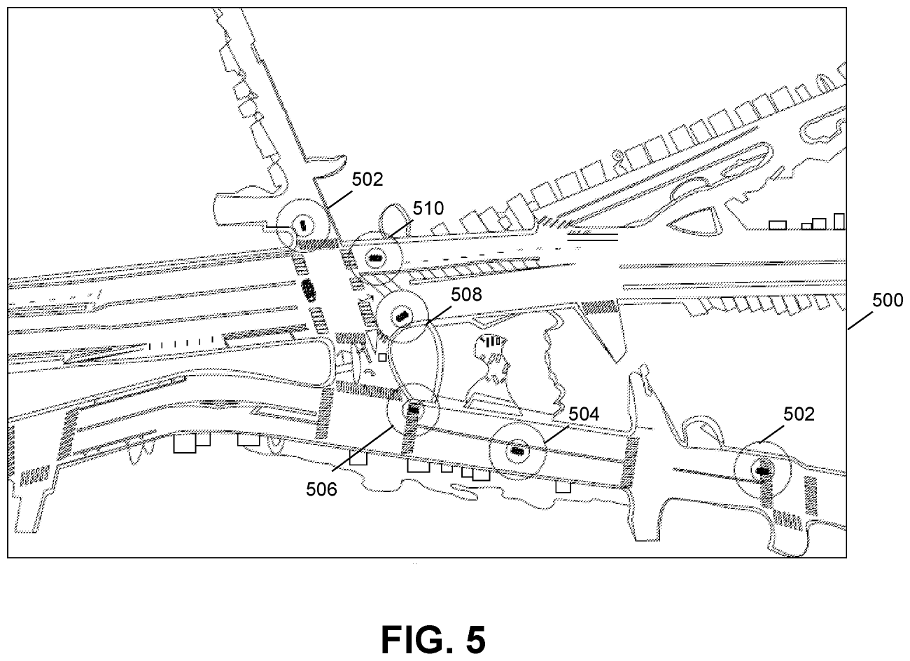

In some embodiments, the analytics server may use a set of egos driving through various environments and aggregate each model generated for each ego in order to generate an aggregated model. Referring now to FIG. 5, the model 500 represents an aggregated model. Specifically, the model 500 comprises models generated using data retrieved from egos 502-510.

Referring back to FIG. 2, at step 230, the analytics server may identify a machine learning label associated with the at least one feature within the image data.

The analytics server may identify the features within the region using the camera feed and/or the 3D model. As discussed herein, the analytics server may use various AI modeling and/or image recognition techniques to identify the features included within the image data, such as traffic signs, traffic lights, lane markings, and the like. Additionally or alternatively, human reviewers may label image data. For instance, a human reviewer may view the camera feed and manually designate a label for different features depicted within the images captured (e.g., camera feed).

In some embodiments, the analytics server may use a hybrid approach where the analytics server may first execute additional neural networks (using the image data) to predict a likely (e.g., initial estimate) label for various features. For instance, an image recognition protocol (e.g., neural network) may generate inferences regarding where the lane lines are located within a camera feed. Subsequently, the initial inference may be confirmed/verified by a human labeler. Moreover, the human labelers can also add, remove, and/or revise any labels generated as the initial inference. The human labelers'interactions can also be monitored and used to improve the models utilized to generate the initial inferences.

At step 240, the analytics server may receive second navigation data and second image data from a second ego not included within the set of egos, the second ego navigating the environment, the second image data including the at least one feature.

The analytics server may receive new image data from a new ego navigating within the region (e.g., the same region as the model discussed herein). The analytics server may retrieve the camera image from one or more of the cameras of the ego. The ego discussed in the step 240 may not be included within the egos that transmit their navigation and/or camera data to the analytics server within the step 210. In some embodiments, the ego discussed with elation to the step 240 may be a part of the egos discussed in relation to the step 210. For instance, data received from an ego may be used to determine how to auto-label camera feeds within a region. As a result, the analytics server may use the auto-labeling paradigm discussed in relation to the method 200 to auto-label the camera feed received from the same ego at a later time. Therefore, no limitation is intended by the description of egos here.

At step 250, the analytics server may automatically generate a machine learning label for the at least one feature depicted within the second image data. Using the model, the analytics server may determine a label associated with one or more features received within the camera feed of the second ego (step 240). In some embodiments, the analytics server may use navigation data of the ego (e.g., location data) to estimate the location and/or trajectory of the ego. For instance, the analytics server may use VIO or IMU data of the ego to identify its trip trajectory and determine where the ego is navigating to/from.

Using this estimated location/trajectory, the analytics server may determine which model to use. The analytics server may align the camera feed of the ego with various camera feeds received in the step 210. As a result, the camera feeds may be aligned such that the labels of the features generated in the step 220-230 can be transferred to the features depicted within the camera feed received in the step 250.

After a model is identified, the analytics server may align and compare the image data of a feature (received from the ego) with a description of the feature, as indicated within the model. For instance, if a video clip captured by a camera of an ego depicts a feature, the analytics server may use VIO, IMU, and other navigation data along with the video clip itself to identify another video clip (captured in the step 210) that includes the same feature. The analytics server may then align the video clips and determine other features depicted within the video clip.

In some embodiments, the camera feed of the new ego may be compared against other image data captured by the set of egos to identify a matching camera feed. After aligning the camera feeds, the analytics server may transfer the label to the new ego's camera feed.

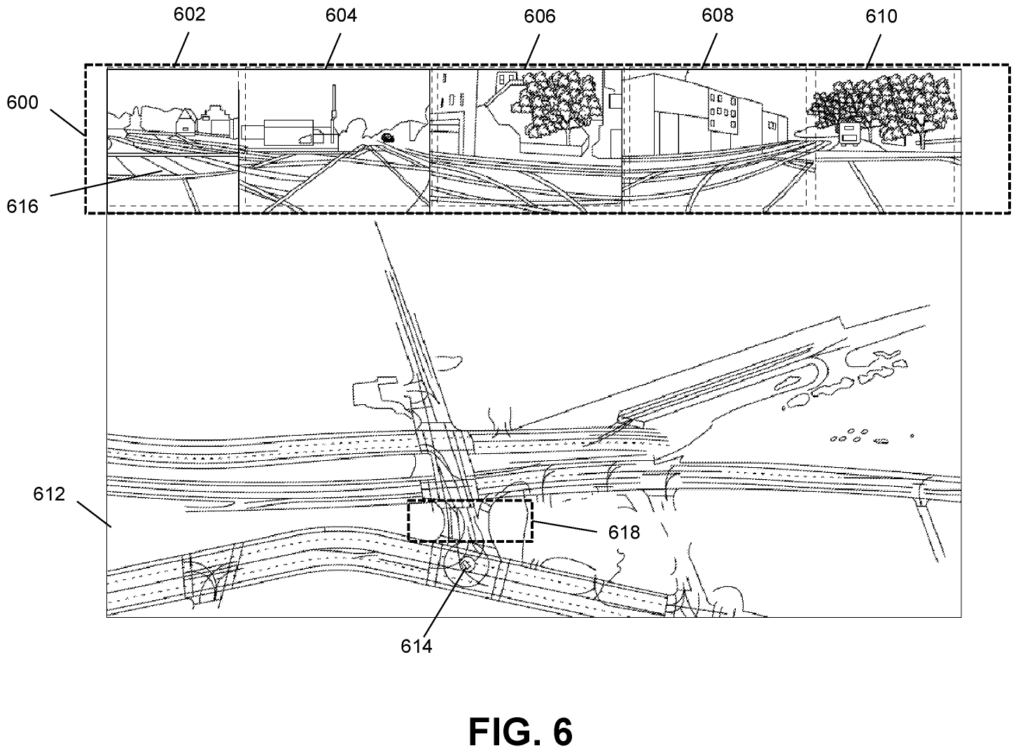

Referring now to FIG. 6, an ego generates the image data 602-610 (collectively the camera feed 600). Using the method 200, the analytics server has already generated a model corresponding to a region within which the ego is navigating. Using location/trajectory data of the ego (or in some embodiments using an image recognition protocol executed using the camera feed), the analytics server may identify a model to be used for the ego where the model identifies various features of the environment. For instance, the analytics server identifies the model 612 and determines that the ego is navigating within an estimated region of 614.

Using the identified model 612, the analytics server may determine one or more features depicted within the camera feed 600. For instance, the image data 602 corresponds to a front camera of the ego and includes a feature of the street in which the ego is navigating (feature 616). Using the model 612, the analytics server determines that the feature 616 is the crosswalk 618 included within the model 612. The analytics server may also identify existing camera footage of the same sidewalk (retrieved from one or more egos that previously navigated through the same street). As a result, the analytics server automatically labels the feature 616 as a crosswalk (e.g., transfer the label from the previous egos to the camera feed 600).

At step 260, the analytics server may optionally train an AI model using the predicted/calculated machine learning label. The machine learning labeling identified using the method 200 (step 250) can be added to the camera feed received from the new ego (step 240) and transmitted an AI model for training purposes. The camera feed and its label can then be ingested by an AI model, such as an occupancy network or occupancy detection model discussed herein, for training or retraining purposes.

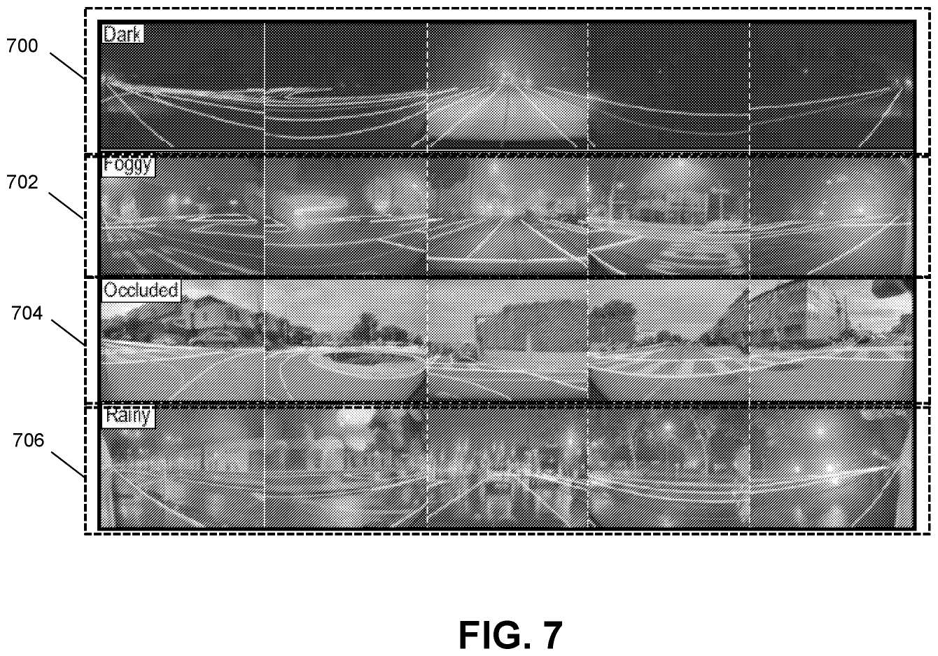

Using the method 200, the analytics server may automatically label various camera feeds captured from different egos. For instance, and referring now to FIG. 7, different camera feeds depicted correspond to the same environment. However, each camera feed corresponds to different conditions (whether weather conditions or otherwise). For instance, camera feed 700 may correspond to dark conditions; camera feed 702 may correspond to foggy conditions; camera feed 704 may correspond to occluded conditions (where an object at least partially obscures one or more features of the region); and camera feed 706 corresponds to raining conditions. While the depicted features are the same, each feature's visual attributes may change depending on the weather conditions. For instance, images of the same feature (captured under different conditions) may look slightly different. Using the method 200, a processor may determine (using the generated model) an indication of the feature, then automatically label the feature as it appears in different camera feeds (e.g., in different conditions or from different angles). In some embodiments, the camera feeds may not include overlapping elements. In some embodiments, the data depicted within FIG. 3 may represent examples of auto-labeling in challenging conditions by transferring the auto-labeling in good condition after registering the clips (drives) from different conditions onto the common 3D model or environment.

Using the methods and systems discussed herein, the analytics server may match/align the camera feed of an environment in a particular weather condition (e.g., fog or raining) to the camera feed of the same environment in sunny weather conditions. Subsequently, the key features can be extracted and the labels generated for the camera feed in sunny weather can be transferred onto the camera feed in fog or raining conditions.

In some embodiments, the 3D model may be enriched with other location data to be transformed into an HD map. The HD map can then be used to localize an ego using vision data retrieved from that ego. For instance, using the camera feed received from an ego, the analytics server (or a local processor of the ego) can match the camera feed to a particular location within the 3D model. This matching may be done by aligning key features of the camera feed (key features indicating a particular structure) with another key feature previously captured by another ego. As a result, using the camera feed and/or other navigational data, a location or trajectory of the ego can be determined, thereby localizing the ego using its camera feed and the 3D model.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or a machine-executable instruction may represent a procedure, function, subprogram, program, routine, subroutine, module, software package, class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code, it being understood that software and control hardware can be designed to implement the systems and methods based on the description herein.

When implemented in software, the functions may be stored as one or more instructions or code on a non-transitory, computer-readable, or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitates the transfer of a computer program from one place to another. A non-transitory, processor-readable storage media may be any available media that can be accessed by a computer. By way of example, and not limitation, such non-transitory, processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that can be accessed by a computer or processor. Disk and disc, as used herein, include compact disc (CD), laser disc, optical disc, digital versatile disc (DVD), Blu-ray disc, and floppy disk, where “disks” usually reproduce data magnetically, while “discs” reproduce data optically with lasers. Combinations of the above should also be included within the scope of computer-readable media. Additionally, the operations of a method or algorithm may reside as one or any combination or set of codes and/or instructions on a non-transitory, processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method comprising:
retrieving, by a processor, a set of navigation data and image data from a set of egos navigating within an environment comprising at least one feature;
generating, by the processor, a three-dimensional (3D) model of the environment using the navigation data and image data of at least a subset of the set of egos, the 3D model comprising a virtual representation of the at least one feature of the environment;
identifying, by the processor, a machine learning label associated with the at least one feature within the image data;
receiving, by the processor, second navigation data and second image data from a second ego not included within the set of egos, the second ego navigating within the environment, the second image data including the at least one feature; and
automatically generating, by the processor, a machine learning label for the at least one feature depicted within the second image data.

2. The method of claim 1, further comprising:
filtering, by the processor, the set of navigation data and image data into a subset of the set of navigation data and image data in accordance with a trajectory of each ego within the set of egos.

3. The method of claim 1, further comprising:
localizing, by the processor, the second ego using the second navigation data or the second image data in accordance with the 3D model.

4. The method of claim 1, wherein the at least one feature is at least one of a drivable surface, a traffic sign, a traffic light, lane lines, or a 3D structure.

5. The method of claim 1, further comprising:
transmitting, by the processor, the machine learning label and the second image data to an artificial intelligence model.

6. The method of claim 5, wherein the artificial intelligence model is an occupancy detection model.

7. The method of claim 1, further comprising:
executing, by the processor, an artificial intelligence model to predict the machine learning label associated with the at least one feature within the image data.

8. The method of claim 7, further comprising:
receiving, by the processor from a human reviewer, a validation regarding the machine learning label associated with the at least one feature within the image data predicted by the artificial intelligence model.

9. A computer-readable medium comprising a set of instructions that when executed, cause a processor to:
retrieve a set of navigation data and image data from a set of egos navigating within an environment comprising at least one feature;
generate a three-dimensional (3D) model of the environment using the navigation data and image data of at least a subset of the set of egos, the 3D model comprising a virtual representation of the at least one feature of the environment;
identify a machine learning label associated with the at least one feature within the image data;
receive second navigation data and second image data from a second ego not included within the set of egos, the second ego navigating within the environment, the second image data including the at least one feature; and
automatically generate a machine learning label for the at least one feature depicted within the second image data.

10. The computer-readable medium of claim 9, wherein the set of instructions further cause the processor to:
filter the set of navigation data and image data into a subset of the set of navigation data and image data in accordance with a trajectory of each ego within the set of egos.

11. The computer-readable medium of claim 9, wherein the set of instructions further cause the processor to:
localize the second ego using the second navigation data or the second image data in accordance with the 3D model.

12. The computer-readable medium of claim 9, wherein the at least one feature is at least one of a drivable surface, a traffic sign, a traffic light, lane lines, or a 3D structure.

13. The computer-readable medium of claim 9, wherein the set of instructions further cause the processor to:
transmit the machine learning label and the second image data to an artificial intelligence model.

14. The computer-readable medium of claim 13, wherein the artificial intelligence model is an occupancy detection model.

15. The computer-readable medium of claim 9, wherein the set of instructions further cause the processor to:
execute an artificial intelligence model to predict the machine learning label associated with the at least one feature within the image data.

16. The computer-readable medium of claim 15, wherein the set of instructions further cause the processor to:
receive, from a human reviewer, a validation regarding the machine learning label associated with the at least one feature within the image data predicted by the artificial intelligence model.

17. A system comprising:
a set of egos; and
a processor in communication with the set of egos, the processor configured to:
retrieve a set of navigation data and image data from a set of egos navigating within an environment comprising at least one feature;
generate a three-dimensional (3D) model of the environment using the navigation data and image data of at least a subset of the set of egos, the 3D model comprising a virtual representation of the at least one feature of the environment;
identify a machine learning label associated with the at least one feature within the image data;
receive second navigation data and second image data from a second ego not included within the set of egos, the second ego navigating within the environment, the second image data including the at least one feature; and
automatically generate a machine learning label for the at least one feature depicted within the second image data.

18. The system of claim 17, wherein the processor is further configured to:
filter the set of navigation data and image data into a subset of the set of navigation data and image data in accordance with a trajectory of each ego within the set of egos.

19. The system of claim 17, wherein the processor is further configured to:
localize the second ego using the second navigation data or the second image data in accordance with the 3D model.

20. The system of claim 17, wherein the at least one feature is at least one of a drivable surface, a traffic sign, a traffic light, lane lines, or a 3D structure.
